(19) United States
(12) Patent Application Publication
(10) Pub. No.: US 2007/0139667 A1
(43) Pub. Date: Jun. 21, 2007

(54) Digitally mapped formulaic color space and method of making and using same

(76) Inventors: Scott O Russell, Avon, OH (US); Susan H. Bates, Dacula, GA (US)

Correspondence Address: POLYONE CORPORATION, 33587 WALKER ROAD, AVON LAKE, OH, 44012, US

(21) Appl. No.: 10/553,474

(22) PCT Filed: Apr. 21, 2004
(86) PCT No.: PCT/US04/12233

§ 371 Date: Oct. 17, 2005

Related U.S. Application Data
(60) Provisional application No. 60/464,719, filed on Apr. 23, 2003.

(51) Int. Cl. G06F 15/00

(52) U.S. Cl. 358/1.9; 358/528

(57) ABSTRACT

A method of mapping color space with chromatic formulations, comprising the steps of (a) selecting a limited number of chromatics for use with a bulk material using selection criteria; (b) formulating the selected chromatics with white or black in the bulk material to generate a plurality of chromatic formulations, wherein such plurality of chromatic formulations populate a desirable volume of color space; and (c) computing additional chromatic formulations using algorithms reflecting the contributions of chromatics, white, and black to color, and incremental substitutions thereof. Optional steps in the method are also disclosed. The result can be a database of generated nodes and computed nodes filling desired regions or even the entirety of color space for a given polymeric bulk material. Usefulness includes the ability create, store and communicate chromatic formulations for the generated nodes, the computed nodes, or both for use anywhere in the world via electronic commerce of color matching.

### CLAIM OF PRIORITY

This application claims priority from U.S. Provisional Patent Application Ser. No. 60/464,719 bearing Attorney Docket Number 12003006 and filed on Apr. 23, 2003, which is incorporated by reference.

### FIELD OF THE INVENTION

This invention relates to a method to produce products having color within a defined location within color space.

### BACKGROUND OF THE INVENTION

Humans benefit from the world of color around us. Our eyes and minds perceive millions of variations in color. Nature brings thousands of colors to our attention every day.

Industry has created products that need color to attract our attention. The dyes and pigments used to make such products colorful are rare and often expensive natural and synthetic products. Whether using the Red-Green-Blue (RGB) additive primary colors or the Cyan-Magenta-Yellow (CMY) subtractive primary colors, people mix pigments or dyes to make color, potentially millions of variations.

Those millions of variations make up color space based on the three factors of Hue, Saturation, and Lightness (HSL). Beginning with Munsell, people have been trying to map color's dimension in color space. The gamut of colors in color space can be articulated in the form of RGB, CMY, or HSL values—all being tristimulus data, which has been standardized by the Commission Internationale d'Eclairage (CIE) to generate such device independent coordinate color space identifiers as CIE XYZ, CIE L*a*b*, CIE L*u*v*, and CIE L*C*H^{o}.

While these device independent tristimulus data systems are excellent means for determining theoretical color, it remains for industry to utilize the spectral data of the incidence of light upon a colored product in order to understand its practical coloration. Most often, spectral data are a curve of intensity values along the visible spectrum's wavelengths of 400-700 nm. Those data are obtained from either observation where light is modified by the illuminated object and reflected back to the observer (reflectance data) or observation where light is modified as it passes through the illuminated object (transmissive data).

Spectral data are gathered by spectrophotometers by those skilled in the art. For purposes of describing this invention, the difference in color between one sample, denominated “a standard color”, and a second sample, denominated “a trial color” is called Delta Error (Delta E or ΔE). There are several popular color models in the industry for calculations of Delta E, some of which are CIELAB, CIE94, CIEDE2000, and CMC.

Objective spectral data are better than subjective human observation for matching a color using existing pigments and dyes, because of variability of human perception. One example of use of such objective spectral data for color matching is disclosed in PCT Patent Publication WO 01/97090 A2.

### SUMMARY OF THE INVENTION

The art needs a means for using objective spectral data to reliably determine chromatic formulations within the vast volume of color space.

“Chromatic” means a dye or a pigment, and a “chromatic formulation” can include one or more dyes, one or more pigments, or a combination of both one dye and one pigment, one dye and multiple pigments, multiple dyes and one pigment, or multiple dyes and multiple pigments. Chromatics can be either organic or inorganic in nature.

More specifically, the art needs a means for identifying chromatic formulations within the universe of color space, particularly in a manner that minimizes the numbers and amounts of chromatics employed to reach such desirable locations in color space, and more particularly in a manner that minimizes metamerism. Most specifically, the art needs a means to map digitally selected locations of, and potentially all of, the universe of color space using formulae which minimizes the number and quantities of chromatics employed.

The present invention solves these problems in the art. More particularly, the solution to the problem in the art is advantageous for, but not limited to, the color concentrates industry for the coloring of polymers, whether in the form of products that have color throughout their bulk (e.g., plastic articles) or products (e.g., inks, toners, and paints) that impart color only on the exposed surface of a substrate.

One aspect of the present invention is a method of mapping color space with chromatic formulations, comprising the steps of (a) selecting a limited number of chromatics for use with a bulk material using selection criteria; (b) formulating the selected chromatics with white or black in the bulk material to generate a plurality of chromatic formulations, wherein such plurality of chromatic formulations populate a desirable volume of color space; and (c) computing additional chromatic formulations using algorithms reflecting the contributions of chromatics, white, and black to color, and incremental substitutions thereof.

“Bulk material” means a material not intentionally already containing chromatic. Non-limiting examples include a polymer resin, a coating binder, other materials suitable for having color therein or thereon, and combinations thereof.

“Selection criteria” means factors utilized by the artisan to distinguish the limited number of chromatics from the vast array of possible chromatics. The selection criteria requires discipline, beginning with recognition of the need for four primary colors (RGBY), black, white, and then variations with such color space regions particularly important to an industry based on the bulk material whose color space is being digitally mapped. Non-limiting examples of selection criteria are commercially popular colors served by individual chromatics, inexpensive readily available chromatics, reliable suppliers of chromatics, locations in color space amply served by individual chromatics, regulatory use approval for such chromatics (e.g., Food and Drug Administration (FDA) approval), and other selection criteria considered important by artisans in a particular color industry.

“Chromatic formulation” means the combination of chromatics with a concentration of white or black or both to yield a color that has a spectral data curve unique to a single location within color space. In some color industries, such as the plastics industry, one calls the chromatic a “mass tone” and its variations with white and black therefrom a “characterization of the lightness of the chromatic”. In other color industries, such as the printing industry, the chromatic is considered being adjusted along a grayscale by such combining with various concentrations of white and black. Regardless of industry terminology, the plot of typically 3-10 datapoints in color space for each chromatic generates a chromatic characterization curve.

While a spectral data curve can be created using any conventional means, a preferred spectral data curve is created using approximately 31 wavelengths along the visible spectrum of 400-700 nm, more preferably spread evenly throughout such range. Thus, in the most preferred embodiment, a chromatic formulation is “fingerprinted” with a y-axis intensity value at every 10 nm of the visible spectrum along the x-axis.

While a spectral data curve can be created using any test sample, a preferred spectral data curve is created using a sample that has been made using a process that yields equivalent results to commercial scale equipment. Preferably, commercial scale extrusion equipment can be employed.

Another aspect of the present invention is the conversion of a chromatic characterization curve populated by about 5 to 6 lightness variations of a given chromatic, selected by the selection criteria, into a spectral data curves for each of 5 to 6 datapoints that can provide data that avoid undesirable metamerism in color matching processes. For example, 6 variations of lightness for one chromatic will yield one chromatic characterization curve within color space but six different spectral data curves, one for each datapoint in color space.

These empirically determined datapoints are called “generated nodes” for purposes of explanation of this invention.

Generated nodes need not occupy color space equidistantly. Indeed, the selection criteria employed may concentrate on chromatics ideal for specific locations in color space. However, it is within the scope of the present invention to select chromatics to populate key regions of color space or all of color space, according to the needs of the particular industry.

An advantage of step (c) of the invention is the ability to compute additional, predictive chromatic formulations in color space without creating actual chromatic formulations in addition to those formulated in step (b).

A location in color space reached via the predictive computing step (c) can employ a differential from a location of a generated node in color space by incremental substitution of black or a chromatic for white as desired by the color matching artisan for precision of color matching within the bounds of gravimetric possibilities. The predictive computing step (c) starts from chromatics formulations and utilizes algorithms and computing software to achieve literally any location other than a generated node and having any scalar and vectoral differentiation from such generated node location. For purposes of explaining this invention, all locations in color space occupied by a chromatic formulation according to this predictive computing step (c) are called “computed nodes”.

It is within the scope of the present invention that step (c) can be employed to populate desired regions of color space for a given bulk material with either a combination of spectral data curve data for generated nodes and computed nodes or merely computed nodes alone.

To provide some context between generated nodes and computed nodes, whereas the order of magnitude of generated nodes within color space is about 2 for a preferred embodiment of the present invention, the order of magnitude of computed nodes within the same color space is about 7 when optional step (c) has been used. In other words, according to this optional aspect of the present invention, one can take as few as 300 generated nodes in color space and compute as many as 2,000,000 computed nodes. In this optional aspect of the present invention, one can populate color space with generated nodes and computed nodes to a resolution at least as much as a conventional computer Cathode Ray Tube (CRT) or Liquid Crystal Display (LCD) screen can generate and almost as much as the human eye can perceive.

Another aspect of the present invention is optionally including step (d) to the method of the invention, wherein step (d) is generating a database of chromatic formulations containing chromatic formulations for generated nodes or chromatic formulations for computed nodes or chromatic formulations for both generated nodes and computed nodes. This database then becomes as robust with specific chromatic formulations, for as many colors as can be displayed on a conventional computer monitor.

Another aspect of the present invention is optionally including step (e) to the method of the invention, wherein step (e) is matching spectral data curves from an actual or virtual object with one or more of the chromatic formulations stored in the database. This step is performed in the objective realm, using spectral data. The matching process of step (e) can employ filters for searching of chromatic formulations in the database, according to fields in the database such as governmental approval for use in food and drug products or packaging therefor, weatherability, heat stability, and the like.

Another aspect of the present invention is optionally including step (f) to the method of the invention, wherein step (f) is communicating the results of spectral data curve matching to a person seeking to match color for the actual or virtual object, wherein the results comprise one or more choices.

Another aspect of the present invention is optionally including step (g) to the method of the invention, wherein step (g) is receiving an instruction by the person to whom the results were communicated in step (f) as to which choice of color match, if any, is selected. Optionally, this choice of color match can add to the database by use of software to generate a chromatic formulation of an additional computed node between two existing nodes within color space, both represented by chromatic formulations in the database. This can be a self-teaching event for the database.

Another aspect of the present invention is optionally including step (h) to the method of the invention, wherein step (h) is ordering the chromatic formulation correlated to the color match selected in step (g) to be prepared for use with a bulk material.

Another aspect of the present invention is optionally including step (i) to the method of the invention, wherein step (i) is mixing the selected chromatic formulation with another material compatible with the bulk material for use with the bulk material to provide color for the bulk material. It is within the scope of this invention to provide color to naturally colored bulk material or already-colored bulk material, both types being altered by the chromatic formulation selected. It is also within the scope of the present invention that the result of the mixture of optional step (i) is either a concentrate for mixing with a final bulk material or a final bulk material compound itself.

Another aspect of the present invention is a method of predicting chromatic formulations in color space for a bulk material, comprising the steps of (1) selecting chromatic formulations via empirical evidence to create generated nodes in color space, and (2) applying algorithms derived from such generated nodes to create computed nodes of chromatic formulations in color space, wherein the algorithms comprise (i) predictions based on variation of black with white; (ii) predictions based on variation of two different chromatics with white; (iii) predictions based on variation of both black and chromatic with white; and (iv) predictions based on variation of two different chromatics with white.

More preferably, such predictions of step (2) result in actual chromatic formulations with virtual color space spectral data curves.

A feature of the invention is the formulaic mapping of color space, with a limited, preferably minimum, number of chromatics, black(s), and white(s).

An advantage of the invention is an objectively created digital map of color space, reflective of a given interaction of bulk material of polymer with chromatic as affected by white or black or both, for the purpose of color matching at minimal cost.

Another advantage of the present invention is the potential to create a universal mapping of color space for a given polymeric bulk material or in specific commercially desirable regions of color space, robust enough to provide color matching surpassing the gamut of colors available in conventional thermoplastics coloration, desirably surpassing the limits of computer visual display screens, and preferably approaching the millions of colors perceptible to the human eye.

Other features and advantages of the invention will become apparent from the description of embodiments of the invention.

### EMBODIMENTS OF THE INVENTION

Bulk Material

Whether in the form of polymeric resins or polymeric binders, the bulk material is polymeric and based on such diverse polymer chemistries as polyolefins, poly(vinyl chloride), polystyrenes, polyesters, polyurethanes, acrylics, etc. The present invention is acceptable for any of the polymer chemistries that are desired to be colored beyond their natural color resulting from polymerization. A non-limiting list of acceptable polymer chemistries can be found at www.polyone.com.

All principal forms of polymer physics are acceptable for use in the present invention: thermoplastic plastics, thermoplastic elastomers, thermoset plastics, thermoset elastomers, and the mixtures of them within such four corners of polymer physics.

Of these polymer chemistries, those thermoplastics useful in forming plastic articles having color are preferred. Among them, polyolefins such as poly(ethylene) and more particularly, high density poly(ethylene) is especially preferred as a candidate for digital mapping of color space for chromatic formulations of generated nodes, and preferably also computed nodes.

Generated Nodes Within Color Space

Selection criteria identified above is a starting point for the artisan skilled in the art to address likely commercial color space regions with such practical realities of inventory control for a modern corporation and governmental regulation for usage of a bulk material having chromaticity therein. Further, one should plan for the future requirements of commercial markets and government regulations. Thus, it may be desirable to avoid chromatics based on heavy metal chemistry or other materials that have been or may in the future be considered to be toxic or environmentally undesirable.

Preferably, a minimum number of chromatics, whites and blacks are employed using the selection criteria, because such selections limit the inventory required to generate colors after a chromatic formulation is created for a generated node.

More preferably, the minimum number of chromatics, black(s), and white(s) are chosen from commercially reputable vendors so that such chromatic formulations are not rendered damaged or extinct by the disappearance of a key ingredient to the chromatic formulation.

Most preferably, the selection of white and black materials to affect the lightness of a given chromatic (i.e., grayscale variability) not only takes into account shades of lightness but also the extremes of black and white also. Optimally, the selection of blacks can be multiple due to the difficulties with matching black. For example, in the printing industry, one can have one color black (“K”), three color black (“C+M+Y”), or four color black (“C+M+Y+K”). The reflectance data for black is particularly susceptible to the source of the black(s) used in a given formulation. And the amount of black to be added to darken a chromatic is minor compared to the amount of white capable of being added to lighten a chromatic.

As an non-limiting example, using high density poly(ethylene) (HDPE) as the candidate base material, step (a) in one embodiment of the method of the present invention was the selection of chromatics using selection criteria described above and best practices of master color matchers. Initially, one thinks of the four primary colors of red, yellow, green, and blue, and then the shaded variations of each, such as phthalo blue red shade and green shade, phthalo green, blue shade, and yellow shade, blue shade red and yellow shade red, etc. As one proceeds through the possibilities within the discipline of the selection criteria, finer shadings and undertones are selected. Applying this rationale, the following 51 commercially available materials appearing in Table 1 below were selected for HDPE color space. The commercial sources can be determined by consultation with an industry chemical supply catalogue or Internet search engines such as www.google.com, without undue effort by one of ordinary skill in the art.

TABLE 1

| Code | Raw Material Name | CI_Name | Family | COLOR | FDA* |
|---|---|---|---|---|---|
| 10 | TIOXIDE R-FC6 WHITE | PIGMENT WHITE 6 | INORGANIC | WHITE | Y |
| 25 | REGAL 660R BLACK POWDER | PIGMENT BLACK 7 | ORGANIC | | N |
| 30 | MPC CHANNEL BLACK | PIGMENT BLACK 7 | ORGANIC | | Y |
| 33 | BK-5099 BLACK OXIDE | PIGMENT BLACK 11 | INORGANIC | | N |
| 40 | HELIOGEN BLUE K7090 | PIGMENT BLUE 15:3 | ORGANIC | BLUE | Y |
| 50 | Heliogen Blue K6903 | PIGMENT BLUE B 15:1 | ORGANIC | BLUE | Y |
| 55 | 34L2000 AZURE BLUE | PIGMENT BLUE 28 | INORGANIC | BLUE | Y |
| 60 | 34L2001 AMAZON BLUE | PIGMENT BLUE 36 | INORGANIC | BLUE | N |
| 70 | NUBIX G-58 ULTRAMARINE | PIGMENT BLUE 29 | INORGANIC | BLUE | Y |
| | BLUE | | | | |
| 85 | NUBIX C-84 ULTRAMARINE | PIGMENT BLUE 29 | INORGANIC | BLUE | Y |
| | BLUE | | | | |
| 95 | NUBIX E-28 ULTRAMARINE | PIGMENT BLUE 29 | INORGANIC | BLUE | Y |
| | BLUE | | | | |
| 100 | HELIOGEN GREEN K-8730 | PIGMENT GREEN 7 | ORGANIC | GREEN | Y |
| 105 | HELIOGEN GREEN K 8605 | PIGMENT GREEN 7 | ORGANIC | GREEN | Y |
| 115 | CHROMIUM OXIDE | PIGMENT GREEN 17 | INORGANIC | GREEN | Y |
| | GREEN G-6099 | | | | |
| 125 | CROMOPHTAL ORANGE GP | PIGMENT ORANGE 64 | ORGANIC | ORANGE | Y |
| 130 | 2920 BRILLIANT ORANGE | PIGMENT ORANGE 79 | ORGANIC | ORANGE | Y |
| 145 | NOVAPERM RED F5RKA | PIGMENT RED 170 | ORGANIC | RED | N |
| 150 | 225-2480 Sunbrite | Pigment Red 60:1 | ORGANIC | RED | N |
| | Scarlet 60:1 | | | | |
| 165 | IRGALITE RED LCB | PIGMENT RED 53:1 | ORGANIC | RED | N |
| 171 | DCC-2782 Barium 2B Red | Pigment Red 60:1 | ORGANIC | RED | N |
| 175 | Lithol Scarlet 4451 | Pigment Red 48:2 | ORGANIC | RED | N |
| 190 | CROMOPHTAL RED 2020 | PIGMENT VIOLET 19 | ORGANIC | RED | Y |
| 195 | CROMOPHTAL MAGENTA P | PIGMENT RED 202 | ORGANIC | RED | Y |
| 200 | CROMOPHTAL PINK PT | PIGMENT RED 122 | ORGANIC | RED | N |
| 205 | PALIOGEN RED K 3911 HD | PIGMENT RED 178 | ORGANIC | RED | Y |
| 210 | CROMOPHTAL RED 2030 | PIGMENT RED 254 | ORGANIC | RED | Y |
| 215 | CROMOPHTAL RED 2028 | PIGMENT RED 254 | ORGANIC | RED | Y |
| 225 | Colortherm Red 110M | PIGMENT RED 101 | INORGANIC | RED | Y |
| 230 | Colortherm Red 130M | PIGMENT RED 101 | INORGANIC | RED | Y |
| 235 | Colortherm Red 180M | PIGMENT RED 101 | INORGANIC | RED | Y |
| 270 | CINQUASIA VIOLET RT-891-D | PIGMENT VIOLET 19 | ORGANIC | VIOLET | Y |
| 275 | CROMOPHTAL VIOLET GT | PIGMENT VIOLET 23 | ORGANIC | VIOLET | N |
| 280 | PREMIER VU UMV (6112) | PIGMENT VIOLET 15 | INORGANIC | VIOLET | Y |
| 290 | SICOTAN BROWN K 2750 FG | PIGMENT YELLOW 164 | INORGANIC | BROWN | N |
| 295 | FERRITAN FZ-1000 | PIGMENT YELLOW 119 | INORGANIC | Tan | Y |
| 300 | NUBITERM Y-905K | PIGMENT YELLOW 119 | INORGANIC | Tan | Y |
| | ZINC FERRITE | | | | |
| 320 | PV FAST YELLOW HG | PIGMENT YELLOW 180 | ORGANIC | YELLOW | Y |
| 325 | IRGALITE YELLOW WGPH | PIGMENT YELLOW 168 | ORGANIC | YELLOW | N |
| 330 | PV FAST YELLOW HGR (11-3071) | PIGMENT YELLOW 191 | ORGANIC | YELLOW | Y |
| 335 | PALIOTOL YELLOW K 2270 | PIGMENT YELLOW 183 | ORGANIC | YELLOW | Y |
| 345 | CROMOPHTAL YELLOW HRPA | PIGMENT YELLOW 191:1 | ORGANIC | YELLOW | Y |
| 350 | CROMOPHTAL YELLOW GRP | PIGMENT YELLOW 95 | ORGANIC | YELLOW | Y |
| 360 | IRGALITE YELLOW WSR-P | PIGMENT YELLOW 62 | ORGANIC | YELLOW | N |
| 400 | CROMOPTHAL YELLOW 3RLP | PIGMENT YELLOW 110 | ORGANIC | YELLOW | Y |
| 420 | 9766 FD&C YELLOW # 6 | PIGMENT YELLOW 104 | ORGANIC | YELLOW | Y |
| 425 | 9765 FD&C YELLOW # 5 | PIGMENT YELLOW 100 | ORGANIC | YELLOW | Y |
| 450 | PALIOTOL YELLOW K 0961 (HD) | PIGMENT YELLOW 138 | ORGANIC | YELLOW | Y |
| 455 | SICOPLAST YELLOW 10-0770 | PIG YEL 138/ | ORGANIC | YELLOW | Y |
| | | PIG YEL 183 | | | |
| 480 | SICOTAN YELLOW K 2001 FG | PIGMENT BROWN 24 | INORGANIC | YELLOW | Y |
| 485 | SICOTAN YELLOW K 1011 | PIGMENT YELLOW 53 | INORGANIC | YELLOW | Y |
| 510 | COLORTHERM 10 | PIGMENT YELLOW 42 | INORGANIC | YELLOW | Y |

*As publicized by the commercial producer or as tested by the applicant, or both.

Table 1 shows 47 chromatics, 3 blacks, and 1 white.

Step (b) resolves the generation of a plurality of chromatic formulations via an iterative process, wherein, without undue experimentation, samples of the commercially available chromatics are combined four levels of white and one level of black to generate five different characters of lightness of each chromatic. Optionally, one can also include the chromatic mass tone in this step. Only one of the three blacks need be selected for the creation of the chromatic characterization curve.

Step (b) generates empirical data by preparing five samples where four samples are a mixture of chromatic with white and one is a mixture of chromatic with black. Table 2 shows a typical characterization mixture set.

TABLE 2

| Chromatic Wt. Percent | White Wt. Percent | Black Wt. Percent |
|---|---|---|
| 10 | 90 | 0 |
| 25 | 75 | 0 |
| 50 | 50 | 0 |
| 75 | 25 | 0 |
| 99 | 0 | 1 |

For HDPE, the iterative process of Steps (a) and (b) culminated in the selection of 47 different commercially available chromatics from reputable vendors, 3 blacks, and 1 white. Black and white represented the extremes (full saturation and no saturation of color, respectively), with 3 blacks being chosen for the preferred reasons described above. Each of the 47 chromatics was adjusted 5 variations of lightness for inorganic pigments and 6 levels of lightness for organic pigments as seen in Table 2—287 possibilities.

For HDPE, such 287 samples were made mixing about 0.5 to about 1.0 weight percent of chromatic formulation with HDPE in a conventional twin screw extruder. The selection of the extruder and its settings can be made to mimic the likely production environment for that bulk material, in effect, a pilot sample performed in a scale-up environment. Therefore, optional other ingredients can be included as known to polymer engineers in the art. The desired variability was only the chromatic formulation. Each of such 287 samples was then tested for a spectral data curve of 31 evenly-spaced points using a Spectraflash 600+ spectrophometer commercially available from Datacolor International Corporation of Charlotte, N.C., USA and other locations worldwide.

It should be appreciated by those skilled in the art who have struggled with the reality of color science, that a single location in color space using tristimulus data of any kind, CIE standardized or not, can be arrived at by any number of actual chemical formulations. Indeed, what is unexpected in the present invention is the recognition of the problem that the ends of location in a color space are not justified the means of achieving such color space location.

It is an unfortunate reality of color science that the very expensive chromatics are often wasted because of unnecessary loadings in chromatic formulations. At some point, additional concentration of a particular color will not affect the ultimate location of that color in color space because of the inevitability of saturation.

Moreover, color matching can be as much as an art as a science when it comes to the adjustments necessary to accommodate chemical and physical properties of the bulk material, the chromatics themselves, or both. All too often, the attempt to achieve a more accurate color match involves adding another chromatic or more of an existing chromatic. Like the filled balloon pushed at one point, another surface is likely to change its character. So too with color matching science.

The present invention unexpectedly begins from the other end of process: using selection criteria to choose specific, limited numbers of chromatics, white(s) and black(s) deliberately and carefully select which such discipline as to their number (preferably the minimal necessary),as to their commercial source, and as to their future viability.

Then, and only then, does the populating of color space in a controlled manner begin according to the present invention to populate a commercially desirable region of color space.

Computed Nodes

Step (c) and step (2) rely on the power of digital computing to populate, by inductive processing, the chromatic formulations for as many as all essentially conceivable locations in color space among the generated nodes. In other words, once possessed of the chromatic formulations of generated nodes for the HDPE universe of color space, one can use algorithms and computer software to create computed nodes at any incremental substitution of black or chromatic for white to locate computed nodes within color space.

Preferably step (c) and step (2) focus on four algorithms vetted to provide precise predictive computing of colorant formulations without empirical experiments.

The first algorithm, identified as algorithm (i) above in the second embodiment of the invention, is a focus on white and black without a chromatic. The prediction is based on variation of a 1.0 weight percent chromatic loading of white, with incremental substitution of black at increments of 4×10⁻⁶ weight percent. In the case of HDPE, the 2.27 grams of white in a simulated HDPE sample of 227 grams was the initial datum point in computed color space, followed by incremental substitution of 0.0001 grams of black.

The incremental substitution of black for white reaches a maximum. In the HDPE prediction, the maximum was about 2.2473 for two of the blacks and about 0.9080 for the BK 5099 Black Oxide black.

The second algorithm, identified above as algorithm (ii), is a focus on white and two chromatics. The prediction is based on variation of a 1.0 weight percent chromatic loading of white, with incremental substitution of one chromatic or the other chromatic at increments of 4×10⁻⁶ weight percent. In the case of HDPE, the 2.27 grams of white in a simulated HDPE sample of 227 grams was the initial datum point in computed color space, followed by incremental substitution of 0.0001 grams of one or the other of the chromatics. The two variables of two chromatics were treated with a variation of one to its maximum and then variation of the other to its maximum. The same maximum can be chosen. For HDPE, it was 2.2473.

The third algorithm, identified above as algorithm (iii), is a focus on white, one chromatic, and black. The prediction is based on variation of a 1.0 weight percent chromatic loading of white, with incremental substitution of one chromatic or black at increments of 4×10⁻⁶ weight percent. In the case of HDPE, the 2.27 grams of white in a simulated HDPE sample of 227 grams was the initial datum point in computed color space, followed by incremental substitution of 0.0001 grams of chromatic or black. The two variables of chromatic and black were treated with a variation of one to its maximum and then variation of the other to its maximum. The incremental substitution of black or chromatic for white reaches a maximum. In the HDPE prediction, the maximum was about 1.5890 for the chromatic and about 0.6696 for each of the three blacks in Table 1.

The fourth algorithm, identified above as algorithm (iv), is a focus on white, two chromatics, and black. The prediction is based on variation of a 1.0 weight percent chromatic loading of white, with incremental substitution of one chromatic or the other chromatic or black at increments of 4×10⁻⁶ weight percent. In the case of HDPE, the 2.27 grams of white in a simulated HDPE sample of 227 grams was the initial datum point in computed color space, followed by incremental substitution of 0.0001 grams of chromatic or black. The three variables of both chromatics and black were treated with a variation of rotation of each to its maximum. The incremental substitution of black or chromatic for white reaches a maximum. In the HDPE prediction, the maximum was about 0.6696 and about 2.2474 for the combination of the two chromatics and black.

Each of the four algorithms can be prepared into flowcharts of logic according to techniques known to those skilled in the art. A commercial source of such technique is Integrated Color Solutions of San Diego, Calif.

Those skilled in the art will recognize some incompatibility of materials is possible among the selection of the chromatics, blacks, and whites chosen under the selection criteria of step (a) and formulated using step (b). In such case, one need not perform step (c) or step (2) of the embodiments of invention to compute such node(s). However, the practice of the present invention does not preclude the computation of all possible combinations.

One can generate matrices to identify which combinations of chromatics need not be computed. Such deletions from computing can be included in the flow charts of logic. Computer software commercially available for the process of rasterizing colors in an image can be employed for this step (c) or step (2). However, a more robust software program from ISO Color of Nanterre, France can be employed, with software code being created flowcharts of logic.

An output data chart can be created from the computer software for the computed nodes of the color space for a given bulk material, in this case HDPE. The output data chart can have identification of color, bulk material, chromatic(s), black(s), white(s), and a simulated spectral data curve and its CIELAB location in color space.

Thus, this step (c) or step (2) of the present invention can provide millions of computed nodes in color space.

These computed nodes from step (c) or step (2) are, in a sense, real chromatic formulations having virtual spectral curve data. The computer hardware and software performs computational mathematics to generate the real chromatic formulations. One can use such computed nodes in substitution for the generated nodes or in addition to the generated nodes that are backed up by real spectral curve data of the generated nodes.

In a preferred embodiment of the invention, one can establish the virtual incremental substitution of black or a chromatic for white for the four algorithms in a such a manner as to nearly saturate, beyond what the human eye can perceive, the desired regions of color space with computed, predictive chromatics formulations.

With sufficient computing capacity and storage capacity, one can essentially fill the universe of color space for a given bulk material of polymer to as refined as resolution as is possible to the limit of gravimetric formulation techniques.

The value of this step (c) or step (2) in the methodology of the present invention is even more important to the color matching artisan than the creation of generate nodes described above. As stated above, but more so, if that artisan is willing to pursue color matching within the inventory of commercial chromatics chosen and used with considerable discipline, then for a given bulk material, that artisan has digital data for an incredibly robust database that benefits not only from actual spectral data curves from actual and precise locations within color space and also computed locations, that do not need actual experimentation to locate.

A commercial business possessing this robust database can immediately perform color matches for desired colors, exceeding anything previously for color matching ever performed and approaching the limits of perception of the human eye.

An actual or virtual object can be selected for color matching using a digital database that can be located at the same site as the object or a remote site using the conventional digital data transmissions now common within single enterprises or across the Internet.

The computed predictive chromatics formulations of computed nodes do not have the empirical results of the generated nodes. However, one can revisit the predicted locations in color space by physically mixing the formulation, as in step (b), for any location, and measuring its actual spectral curve in order to ascertain the standard errors of prediction and other statistical corroborations. In such manner, the millions of computed nodes can be double-checked against the reality of generated nodes, at the discretion of the color artisan. This may be desirable in regions of color space where the only nodes in such color space are computed nodes.

Optional Database and Other Steps

As explained above, usefulness of both embodiments of the invention benefits from the ease of personal computer and client/server computing technology.

The remaining optional steps can proceed from step (c) for one embodiment of the invention or from step (2) of another embodiment of the invention.

Optional step (d) or (3) generates a database from the color formulations of generated nodes, computed nodes, or both in the color space. Preferably, the efforts shown in Table 7 are employed.

Optional step (e) or (4) matches the color of a target object (actual or virtual) with chromatic formulations in the database.

Optional step (f) or (5) communicates the results of the color matching step (e) or (4), usually with a number of choices and simulations of color display for the artisan to select the most precise color, and hence the most precise chromatic formulation for further usage.

Optional step (g) or (6) receives an instruction as to the selection made in step (f) or (5), and optional step (h) or (7) initiates an order for the chromatic formulation to be prepared for commercial usage in the mixing of optional step (i).

All of optional steps (d)-(i) or (3)-(7) are not unconventional in the color matching industry. But none of these steps has benefited from the robust creation of generated nodes using selection criteria, and from computed nodes within a color space for a specific bulk material.

Indeed, the present invention contemplates parallel universes of color space, wherein a separate database exists for each bulk material to be enhanced by color. Moreover, the present invention contemplates a unique digitally mapped formulaic color space for each of the myriad of blends and alloys of different bulk materials that are likely to require the enhancement of color.

Moreover, the present invention recognizes the possibility of adding the naturally-occurring color of the bulk material to the calculus of the algorithmic computation of computed nodes, thereby further matching the uniqueness of the bulk material—homopolymeric, copolymeric, blended, or alloyed with the color space customized for such bulk material.

Non-limiting examples of commercially available computer hardware and software particularly adaptable for the usage of such database and for the performance of color matching are any personal computer with robust computing speed, dynamic memory, and ample data storage space, such as an Apple Power Mac G4 made by Apple Computer of Cupertino, Calif., USA. Preferably, one computer is used to obtain the spectral data curve from the actual or virtual object and a second computer (in the same room or thousands of miles away) provides the color matching.

The art of computerized color matching has improved greatly in recent years. Non-limiting examples of the uses of spectral color data matching are disclosed in PCT Patent Publication WO 01/97090 A2.

More specifically, one can refer to the flow charts of color matching and quality control disclosed as FIGS. 3 and 4 and associated text in PCT Patent Publication WO 01/97090 A2, which are usefull descriptions of the downstream usage of the optional database of the present invention.

Optional Other Ingredients

Frequently, the preparation of a color match does not involve merely color but also special effect features, such as Granite, Translucent, Transparent, Pearls, Metallics, Fluorescents, Iridescents, Marbles, etc. The present invention contemplates the advantage of the generated nodes and computed nodes in a color space for a specific bulk material to then be further enhanced by the selection of such special features, which themselves are generated by additives to the color formulation. Non-limiting examples of such additives are commercially available from Polyone Corporation of Avon Lake, Ohio, USA (www.polyone.com) and marketed under the following brands: Hanna FX chromatics, Polyone chromatics etc.

The disclosure of U.S. Pat. No. 6,524,694 (Phillips) concerns compositions for imparting a translucent optical effect to transparent thermoplastic polymers.

Moreover, additives also include processing enhancement additives for the article formation process, whether by extrusion or molding techniques. Additives can also include performance enhancement additives for the finished article so formed. Non-limiting examples of such additives are commercially available from Polyone Corporation of Avon Lake, Ohio, USA (www.polyone.com) and marketed under the OnCap brand. Additional disclosure of additive concentrates is found in U.S. Pat. No. 6,384,002 (Nitzsche) and U.S. Patent Application Publications 20020193267; 20020198121; 20020198122; and 20020198123.

Usefulness of the Invention

By synthesis of deduction to create generated nodes and induction to create computed nodes, the entire volume of color space is capable of being encoded. Digital mapping of such color space for a specific polymer serving as a bulk material (in either plastic products or as binders for coatings) can now be matched for color using formulaic means not previously available to the color-matching artisan. Even an inexperienced color matcher can obtain an excellent formula for a match in a matter of seconds rather than several minutes to an hour.

Minimization of inventory of chromatics, black(s), and white(s) reduces raw material costs for the color matching enterprise. Discipline dictated by the chromatic formulations reduces finished goods costs for the color matching enterprise.

Objectively obtained chromatic formulations for the entirety of color space for a given polymer provide objective, predictable, and reproducible results.

The ability to store and communicate such chromatic formulations for use anywhere in the world opens the possibilities of electronic commerce of color matching into new territories of reliability and versatility. For example, a single color matcher located in one location can perform a color match with a totally unexpected level of reproducibility and communicate that match to colleagues on five continents around the world, to serve a single global customer's local production needs in response to a global branding strategy.

Industries served by the present invention include apparel, automotive, colorants, cosmetics, food, inks, packaging, paints, plastics, textiles, and many others.

The invention is not limited to the above embodiments. The claims follow.

What is claimed is:

1. A method of mapping color space with chromatic formulations, comprising the steps of:
(a) selecting a limited number of chromatics for use with a bulk material using selection criteria;
(b) formulating the selected chromatics with white or black in the bulk material to generate a plurality of chromatic formulations, wherein such plurality of chromatic formulations populate a desirable volume of color space; and
(c) computing additional chromatic formulations using algorithms reflecting the contributions of chromatics, white, and black to color, and incremental substitutions thereof.

2. The method of claim 1, wherein the algorithms comprise:
(i) predictions based on variation of black with white;
(ii) predictions based on variation of two different chromatics with white;
(iii) predictions based on variation of both black and chromatic with white; and
(iv) predictions based on variation of two different chromatics with white.

3. The method of claim 2, optionally including
(d) generating a database of chromatic formulations containing chromatic formulations for generated nodes, chromatic formulations for computed nodes, or both.

4. The method of claim 3, optionally including
(e) matching spectral data curves from an actual or virtual object with one or more of the chromatic formulations stored in the database.

5. The method of claim 4, optionally including
(f) communicating the results of spectral data curve matching to a person seeking to match color for the actual or virtual object, wherein the results comprises one or more choices.

6. The method of claim 5, optionally including
(g) receiving an instruction by a person to whom the results were communicated in step (f) as to which choice of color match, if any, is selected.

7. The method of claim 6, optionally including
(h) ordering the chromatic formulation correlated to the color match selected in step (g) to be prepared for use with a bulk material.

8. The method of claim 7, optionally including
(i) mixing the selected chromatic formulation with another material compatible with the bulk material for use with the bulk material to provide color for the bulk material.

9. A chromatic formulation computed according to the method of claim 1.

10. A method of predicting chromatic formulations in color space for a bulk material, comprising the steps of:
(1) selecting chromatic formulations via empirical evidence to create generated nodes in color space, and
(2) applying algorithms derived from such generated nodes to create computed nodes of chromatic formulations in color space, wherein the algorithms comprise:
(i) predictions based on variation of black with white;
(ii) predictions based on variation of two different chromatics with white;
(iii) predictions based on variation of both black and chromatic with white; and
(iv) predictions based on variation of two different chromatics with white.

11. The method of claim 10, wherein the predictions of step (2) result in actual chromatic formulations with virtual color space spectral data curves.

12. A computed node of a chromatic formulation in color space made according to the method of claim 10.
